(19) United States
(12) Patent Application Publication
(10) Pub. No.: US 2009/0147932 A1
(43) Pub. Date: Jun. 11, 2009

(54) ENHANCED PROGRAMMING MODEL AND CONTROLLER FOR IVR

(75) Inventors: Thomas McGuire, Beaverton, OR (US); Kevin Noall, Beaverton, OR (US)

Correspondence Address: Stolowitz Ford Cowger LLP, 621 SW Morrison St, Suite 600, Portland, OR, 97205, US

(73) Assignee: Genesis Financial Solutions, Inc., Beaverton, OR (US)

(21) Appl. No.: 12/234,035

(22) Filed: Sep. 19, 2008

Related U.S. Application Data
(60) Provisional application No. 60/973,732, filed on Sep. 19, 2007.

(51) Int. Cl. H04M 11/00

(52) U.S. Cl. 379/88.18

(57) ABSTRACT

One solution for dealing with complex call flows employs a diagramming tool that allows a designer to graphically represent the customer experience during the call by connecting IVR actions and decision points with arrows. The resulting diagram is translated into a Finite State Machine (FSM).

### CROSS REFERENCE TO RELATED APPLICATIONS

This application claims the benefit under 35 U.S.C. 119(e) of U.S. Provisional Patent Application No. 60/973,732, filed Sep. 19, 2007.

### BACKGROUND OF THE INVENTION

FIG. 1 shows a traditional model of Interactive Voice Response (IVR) programming.

IVR programming using hierarchical java-based programming models makes expressing and organizing complex call-flows very challenging. The disclosure that follows solves this and other problems.

### BRIEF DESCRIPTION OF THE DRAWINGS

FIG. 1 illustrates a traditional model of Interactive Voice Response (IVR) programming.

FIG. 2 illustrates an enhanced model of IVR programming.

FIG. 3 illustrates an example call flow generated using the example call designer illustrated in FIG. 2.

FIG. 4A illustrates a first view of a Finite State Machine (FSM) data diagram relating to the example controller shown in FIG. 2.

FIG. 4B illustrates a second view of a Finite State Machine (FSM) data diagram shown in FIG. 4A.

FIG. 5 illustrates an example continuous fetch-execute cycle to be used by the controller shown in FIG. 2.

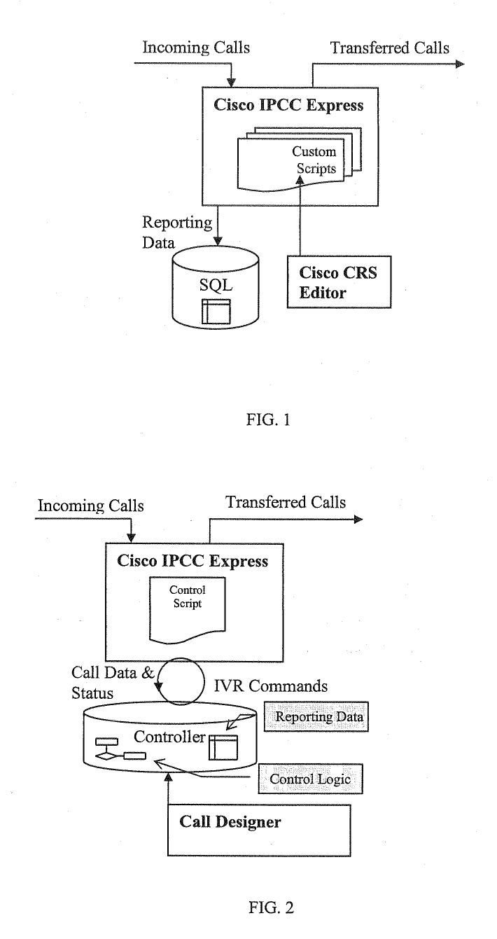

### DETAILED DESCRIPTION

### Overview

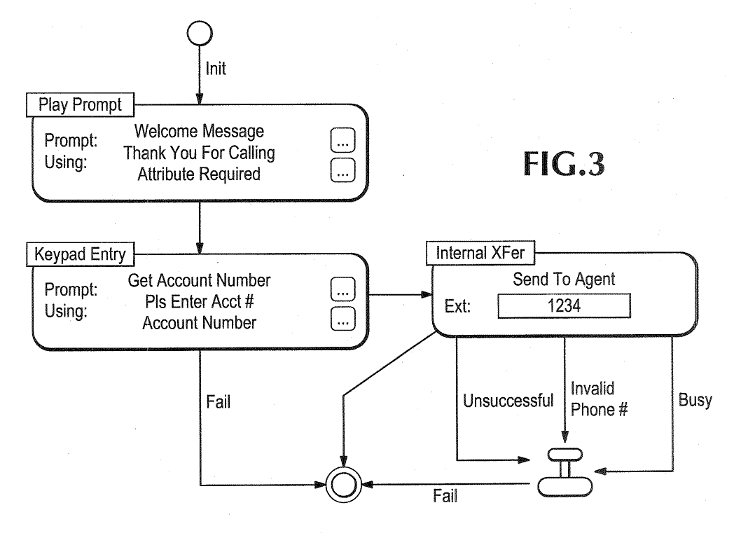

FIG. 2 illustrates an enhanced model of Interactive Voice Response (IVR) programming for contrast with the traditional model of IVR programming.

Our solution for dealing with complex call flows employs a diagramming tool that allows a designer to graphically represent the customer experience during the call by connecting IVR actions and decision points with arrows. The resulting diagram is translated into a Finite State Machine (FSM).

The invention replaces the traditional model of IVR programming—custom IVR scripts—with a single Control Script tightly integrated with a separate Controller application. During a call, a Controller program executes the FSM and communicates information to the IVR via a special Control Script. Each step and path taken by the Controller is logged for later reporting/analysis. The solution:
1. Provides a more versatile, open and friendly development environment for IVR Programming.
2. Improves the visibility of the customer experience created by the IVR
3. Allows for rapid changes to the customer experience by people not trained in computer programming.
4. Closes any reporting gaps currently created by the Cisco call reporting scheme.

The following steps outline the process of using the invention:
1. A diagram of the call flow is created using the Designer
2. A translation of the diagram into a Finite State Machine (FSM) is performed and the result is stored in a database
3. An incoming call is handled by a Control Script running on the Cisco IVR. The Control Script sends a message to the Controller that a call has been received.
4. The Controller runs parallel to the Control Script, interprets the FSM, and directs the Control Script to execute functions within the IVR.

### PREFERRED EXAMPLE

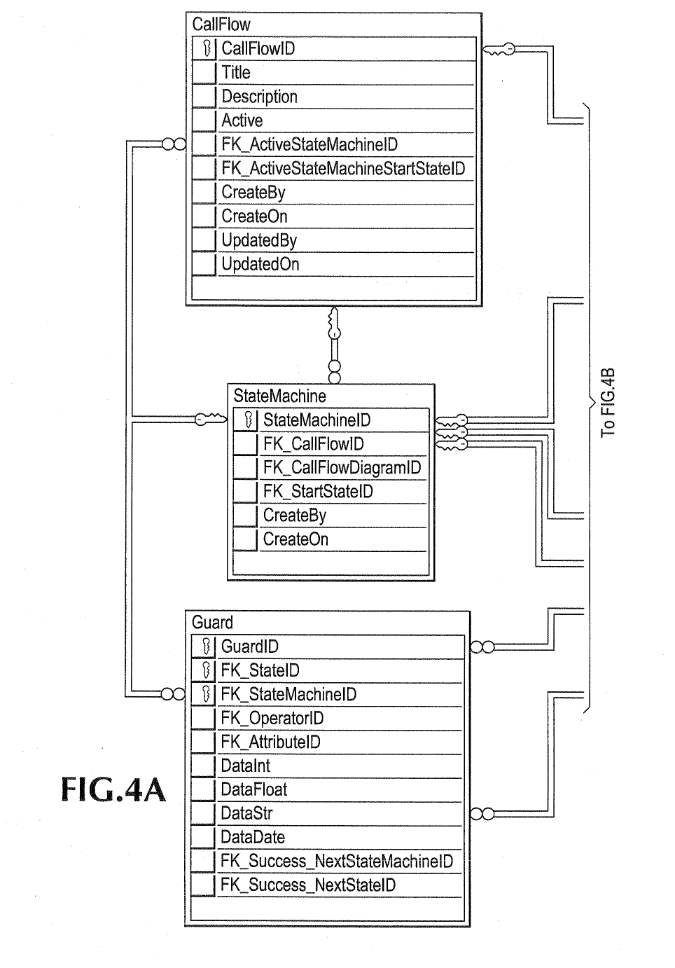

FIG. 3 illustrates an example call flow generated using the example call designer illustrated in FIG. 2.

The Designer features Drag and Drop and other graphical user interface gestures to position widgets along a call path. Each widget depicts an action to be carried out by the system during a call. Arrows are used to represent the flow of the call from one widget (i.e. action) to the next; or through decision points where the flow of the call may change based on data gathered during the call.

The FIG. 3 shows a trivial call flow in the designer. The incoming call immediately goes to a ‘Play Prompt’ action, and then to a ‘Keypad Entry’ action. If the user enters their account number, the call is transferred to an internal extension. If something goes wrong at any point the call is disconnected (only to simplify the diagram—not indicative of an actual call flow).

To construct the state machine used by the controller, a directed graph is created based on the diagram using the actions as nodes and the arrows as edges. For each node of the graph, an entry into a database table is created to contain the details of the action, and the success/failure conditions under which the action may complete.

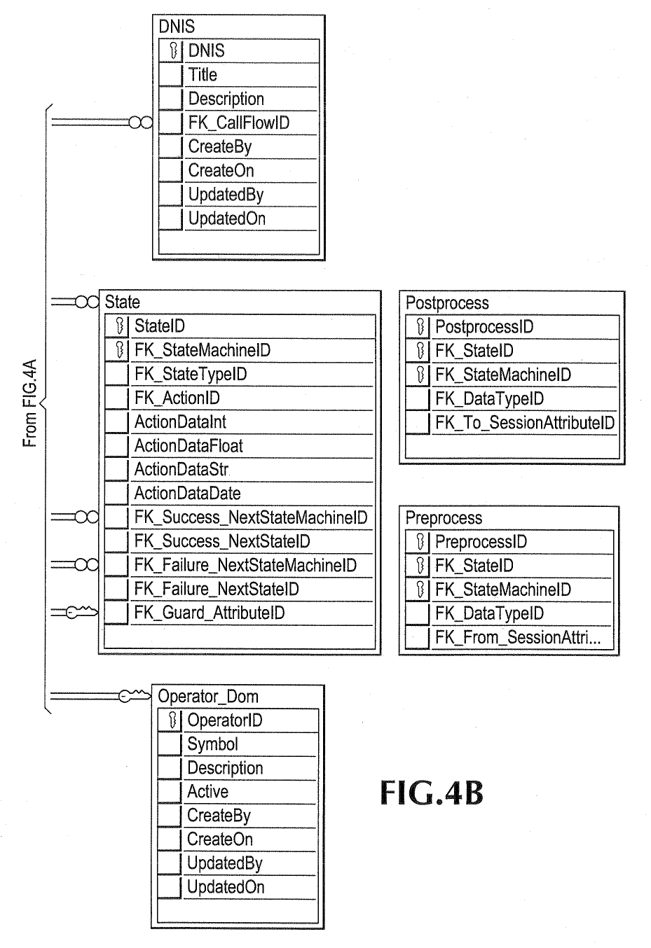

FIGS. 4A-B illustrates a Finite State Machine (FSM) data diagram relating to the example controller shown in FIG. 2.

The Controller application is implemented as a series of T-SQL stored procedures which execute a specialized Finite State Machine. The FSM supports the following types of states:

1. The Entry State

Each FSM contains one and only one Entry State. The Entry State is the starting point of the machine. The Entry State may have no transitions into the state and must have one transition out of the state. The transition out of the Entry State is automatically invoked by the Controller.

2. The Action State

An action state is used to model an action to be performed by the system. Each state defines on Action to be executed by the system along with pre and post-processing steps to be performed by the database.

An Action State may have zero or an unlimited number of transitions into the state.

The events on which an Action State may transition to another state are limited to one ‘Success’ and zero or one ‘Failure’ events.

The state's Action may be performed by either the IVR or the database.
a. IVR Action State—When the FSM enters an IVR Action State, the IVR Action and accompanying data are transmitted to the IVR for execution.
b. Database Action State—When the FSM enters a Database Action State, a stored procedure is invoked that will return a success/failure result similar to an IVR Action.

The success/failure result of the Action motivates the FSM to transition to the next state.

3. The Choice-Point State

The Choice-Point State allows the FSM to branch to one of many different states. Upon entering a Choice-Point State, the FSM evaluates a series of Guard Conditions and selects the first transition out of the state for which the Guard Condition is met.

4. The Unchecked Failure State

Each FSM defines one and only one Unchecked Failure State. The UFS is automatically entered whenever an Action State returns a Failure result, and no Failure transitions are defined for that state. This allows the designer to attempt to recover from a non-fatal error condition within the FSM.

5. The Exit State

Each FSM contains one and only one Exit State. The Exit State is defined as a single state with an Entry Action that instructs the IVR to terminate the script execution.

To provide a context to the FSM, a Call Session defines the instance of the FSM servicing a given phone call, and several Session Attributes are available for population and querying by Action and Choice-Point states.

Each incoming phone call is tracked by the controller using a record in the Session table. The SessionID generated by the IVR is used to tie the two systems together.

TABLE 1

| Field | Type | Remarks |
|---|---|---|
| SessionID | int | Unique¹ identifier provided by the IVR |
| | | upon receipt of a call. May be used to |
| | | tie data from the IVR with data |
| | | generated by the invention during |
| | | FSM execution |
| Active | bit | Indicates a live call in progress |
| FKStateMachineID | int | The current FSM servicing the call |
| FKCurrentStateID | int | The current state of the servicing FSM |
| FKSession- | int | The reason why the call ended (one of: |
| TerminationID | | Unknown: No reason captured for |
| | | the call termination. This is the |
| | | default value |
| | | Normal: The call terminated as |
| | | directed by the call flow |
| | | Hangup: The caller disconnected |
| | | during the call flow execution |
| | | Error: The call flow was |
| | | interrupted by a system error. |
| CreatedAt | DateTime | Call receipt Timestamp |
| DeactivatedAt | DateTime | Call termination Timestamp |

¹Presumed to be sufficiently unique to avoid collisions within a time-span defined by the IVR's MTBF.

To store data generated during the call session, a table of attributes is used. These session attributes allow the invention to store information provided by the caller, or other systems (CRM, Payment, etc. . . . ). As the FSM executes, information is populated as a result of IVR Actions, queried by Choice-Points to determine the call flow, and may be communicated to the caller through the IVR.

Session attributes are stored in the SessionAttribute Value table.

TABLE 2

| | | |
|---|---|---|
| Field | Type | Remarks |

The SessionAttributeValue Table

| | | |
|---|---|---|
| SessionID | bigint | |
| HitCount | int | |
| FKCustomerSystemID | int | |
| AccountNumber | varchar(64) | |
| ErrorStatus | char(1) | |
| ANI | varchar(15) | |
| DNIS | varchar(15) | |
| Language | int | The language of the call |

(other data - implementation specific)

| | | |
|---|---|---|
| ActionResultInt | int | Registers holding the output of |
| ActionResultFloat | float | the most-recently completed |
| ActionResultDate | DateTime | action state. |
| ActionResultString | varchar(2000) | |
| ActionRandomNumber | float | |

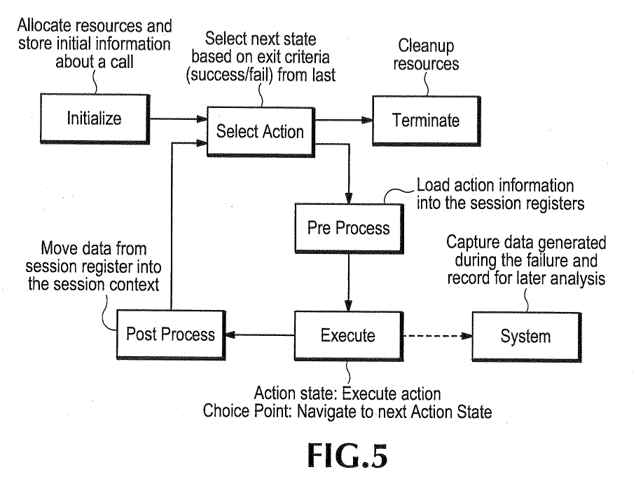

FIG. 5 illustrates an example continuous fetch-execute cycle to be used by the controller shown in FIG. 2.

Once engaged by an incoming call, the controller executes a continuous fetch-execute cycle until reaching a termination state in the FSM. If a fatal error is encountered during the cycle, the state machine immediately terminates and records any information generated during the failure.

Each state in the FSM is modeled in the database as a record in the State table.

TABLE 3
The State Table

| Field | Type | Remarks |
|---|---|---|
| StateID | int | Combined primary key |
| FKStateMachineID | int | |
| FKStateTypeID | int | Type of state {Start, Action, |
| | | Choice-Point, End} |
| FKActionID | int | IVR Action |
| ActionDataInt | int | Registers holding input values to be |
| ActionDataFloat | float | sent to the Action state |
| ActionDataStr | varchar(2000) | |
| ActionDataDate | DateTime | |
| FKSuccessNextStateID | int | |
| FKSuccessNextStateMachineID | int | |
| SuccessTransitionGUID | varchar(32) | Unique identifier recorded when the |
| | | FSM follows this transition |
| FKFailureNextStateID | int | |
| FKFailureNextStateMachineID | int | |
| FailureTransitionGUID | varchar(32) | Unique identifier recorded when the |
| | | FSM follows this transition |
| FKGuardAttributeTypeID | int | |
| FKGuardAttributeID | int | Session attribute whose value forms |
| | | the left-hand side of the guard |
| | | condition expression (Choice-Point |
| | | state only) |

The expressions used to determine the transition out of a Choice Point are stored as records in the Guard table.

TABLE 4
The Guard Table

| Field | Type | Remarks |
|---|---|---|
| GuardID | int | Combined primary key |
| FKStateID | int | |
| FKStateMachineID | int | |
| FKOperatorID | int | The operator to use when forming |
| | | the guard condition expression. |
| FKAttributeID | Int | Unless specifically provided within |
| | | the record, the session attribute |
| | | whose value will serve as the right- |
| | | hand side of the guard condition |
| | | expression |
| DataInt | int | Literal values defined by the guard |
| DataFloat | float | condition. |
| DataStr | varchar(2000) | |
| DataDate | DateTime | |
| FKSuccessNextStateID | int | Destination for the FSM if this |
| FKSuccessNextStateMachineID | int | condition evaluates as ‘true’ |
| SuccessTransitionGUID | varchar(32) | |

When the FSM enters a Choice-Point state, an expression is created for each guard in the form of:
(Session Attribute) (Operator) (Guard Literal) (Session Attribute)

The first expression that evaluates as true is used to select the transition out of the state.

Each Action State may reference zero or more pre and post-processing instructions. These instructions affect the FSM's session information and are used to move data into and out of the Session table from the ActionDatax and ActionResultx IVR command fields. Pre and post processing instructions are stored in the Preprocess and Postprocess tables.

TABLE 5

| | | |
|---|---|---|
| Field | Type | Remarks |

The Preprocess Table

| | | |
|---|---|---|
| PreprocessID | int | Combined primary key |
| FKStateID | int | |
| FKStateMachineID | int | |
| FKDataTypeID | int | The type of data to move |
| FKFromAttributeTypeID | int | |
| FromAttributeID | int | The session attribute to move |

The PostProcess Table

| | | |
|---|---|---|
| PostprocessID | int | Combined primary key |
| FKStateID | int | |
| FKStateMachineID | int | |
| FKDataTypeID | int | The type of data to move |
| FKToAttributeTypeID | int | |
| ToAttributeID | int | The session attribute to move |

### Control Script

The Control Script is the only piece of the invention implemented using the Cisco CRS Editor. The script is automatically invoked by the Cisco IVR whenever a call is received. The script accepts the call, makes a call into the controller to initialize the call's session, and begins the fetch-execute cycle.

The Control Script supports the following IVR Commands:

1. Audible prompts

1.1. Play Prompt

The Play Prompt action causes the IVR system to play a prompt contained in a .wav file found on the server.

| Input | | Output | |
|---|---|---|---|
| Field Name | Value | Field Name | Value |
| Action | 1 | ActionResultSuccess | true |
| ActionDataInt | | ActionResultInt | |
| ActionDataFloat | | ActionResultFloat | |
| ActionDataStr | .wav Filename | ActionResultStr | |
| ActionDataDate | | ActionResultDate | |

| | |
|---|---|
| Success Conditions | The Play Prompt action will always return true. If |
| | the filename specified in the ActionDataStr does |
| | not exist on the server, no error condition is |
| | reported by the IVR. |
| Failure Conditions | |
| Execution Context | IVR |

1.2. Play Money Prompt

| Input | | Output | |
|---|---|---|---|
| Field Name | Value | Field Name | Value |
| Action | 7 | ActionResultSuccess | true |
| ActionDataInt | | ActionResultInt | |
| ActionDataFloat | Currency Value | ActionResultFloat | |
| ActionDataStr | [.wav filename] | ActionResultStr | |
| ActionDataDate | | ActionResultDate | |

| | |
|---|---|
| Success Conditions | The Play Money prompt action always returns true. |
| | If the filename specified in the ActionDataStr does |
| | not exist on the server, no error condition is reported |
| | by the IVR, and the prompt is limited to the |
| | currency prompt. |
| Failure Conditions | |
| Execution Context | IVR |

1.3. Play Date Prompt

| Input | | Output | |
|---|---|---|---|
| Field Name | Value | Field Name | Value |
| Action | 8 | ActionResultSuccess | true |
| ActionDataInt | | ActionResultInt | |
| ActionDataFloat | | ActionResultFloat | |
| ActionDataStr | [.wav filename] | ActionResultStr | |
| ActionDataDate | Date Value | ActionResultDate | |

| | |
|---|---|
| Success | The Play Date prompt action always returns true. |
| Conditions | If the filename specified in the ActionDataStr does not |
| | exist on the server, no error condition is reported |
| | by the IVR, and the prompt is limited to the date |
| | prompt. |
| Failure | |
| Conditions | |
| Execution | IVR |
| Context | |

1.4. Play Integer Prompt

| Input | | Output | |
|---|---|---|---|
| Field Name | Value | Field Name | Value |
| Action | 13 | ActionResultSuccess | true |
| ActionDataInt | Integer Value | ActionResultInt | |
| ActionDataFloat | | ActionResultFloat | |
| ActionDataStr | [.wav filename] | ActionResultStr | |
| ActionDataDate | | ActionResultDate | |

| | |
|---|---|
| Success Conditions | The Play Integer prompt action always returns true. |
| | If the filename specified in the ActionDataStr does |
| | not exist on the server, no error condition is reported |
| | by the IVR, and the prompt is limited to the integer |
| | prompt. |
| Failure Conditions | |
| Execution Context | IVR |

1.5. Play Decimal Prompt

| Input | | Output | |
|---|---|---|---|
| Field Name | Value | Field Name | Value |
| Action | 16 | ActionResultSuccess | true |
| ActionDataInt | | ActionResultInt | |
| ActionDataFloat | Number Value | ActionResultFloat | |
| ActionDataStr | [.wav filename] | ActionResultStr | |
| ActionDataDate | | ActionResultDate | |

| | |
|---|---|
| Success Conditions | The Play Decimal prompt action always returns true. |
| | If the filename specified in the ActionDataStr does |
| | not exist on the server, no error condition is reported |
| | by the IVR, and the prompt is limited to the |
| | decimal prompt. |
| Failure Conditions | |
| Execution Context | IVR |

1.6. Play Spelled Prompt

| Input | | Output | |
|---|---|---|---|
| Field Name | Value | Field Name | Value |
| Action | 21 | ActionResultSuccess | true |
| ActionDataInt | | ActionResultInt | |
| ActionDataFloat | | ActionResultFloat | |
| ActionDataStr | [.wav filename,]Text | ActionResultStr | |
| | To Spell | ActionResultDate | |
| ActionDataDate | | | |

| | |
|---|---|
| Success Conditions | The Play Spelled prompt action always returns true. |
| | If the filename specified in the ActionDataStr does |
| | not exist on the server, no error condition is reported |
| | by the IVR, and the prompt is limited to the spelled |
| | prompt. |
| Failure Conditions | |
| Execution Context | IVR |

1.7. Play Text-To-Speech Prompt

| Input | | Output | |
|---|---|---|---|
| Field Name | Value | Field Name | Value |
| Action | 22 | ActionResultSuccess | true |
| ActionDataInt | | ActionResultInt | |
| ActionDataFloat | | ActionResultFloat | |
| ActionDataStr | [.wav filename,]Text | ActionResultStr | |
| | To Say | ActionResultDate | |
| ActionDataDate | | | |

| | |
|---|---|
| Success Conditions | The Play Text-To-Speech prompt action always |
| | returns true. If the filename specified in the |
| | ActionDataStr does not exist on the server, no |
| | error condition is reported by the IVR, |
| | and the prompt is limited to the |
| | TTS prompt. |
| Failure Conditions | |
| Execution Context | IVR |

### Entering Information

1.8. Prompt For Currency Value

| Input | | Output | |
|---|---|---|---|
| Field Name | Value | Field Name | Value |
| Action | 9 | ActionResultSuccess | true/false |
| ActionDataInt | Number of | ActionResultInt | |
| | Retries | | |
| ActionDataFloat | | ActionResultFloat | Currency |
| | | | Value |
| ActionDataStr | .wav filename | ActionResultStr | |
| | (prompt), | ActionResultDate | |
| | .wav filename | | |
| | (fail msg) | | |
| ActionDataDate | | | |

| | |
|---|---|
| Success Conditions | User must have entered a numeric value that |
| | may be parsed into a floating-point number. The |
| | number the user entered is divided by 100 |
| | and returned in the ActionDataFloat field. |
| Failure Conditions | The user fails to enter a valid number after |
| | ActionDataInt attempts. |
| Execution Context | IVR |

1.9. Prompt For Date Value

| Input | | Output | |
|---|---|---|---|
| Field Name | Value | Field Name | Value |
| Action | 10 | ActionResultSuccess | True/false |
| ActionDataInt | Number of | ActionResultInt | |
| | Retries | | |
| ActionDataFloat | | ActionResultFloat | |
| ActionDataStr | .wav filename | ActionResultStr | |
| | (prompt), | ActionResultDate | Date |
| | .wav filename | | Value |
| | (fail msg) | | |
| ActionDataDate | | | |

| | |
|---|---|
| Success | User must have entered an 8 digit number where the first two |
| Conditions | digits represent the month, second two digits represent the |
| | day, and the last four digits represent the year. |
| | The year must be within the range 1900→2026 (inclusive). |
| | The month must be within 01→12 (inclusive). |
| | The day must be within 01→31 (inclusive) except for the |
| | following conditions: |
| | If the month is 2 (February) then the day must be within |
| | 01→28 (inclusive) unless the year is a Leap Year² in which |
| | case the day is allowed to be 29. |
| | If the month is 4 (April), 6 (June), 9 (September) or 11 |
| | (November) the day must be within 01→30 (inclusive). |
| Failure | This action will fail if the user does not enter 8 digits that |
| Conditions | form a valid date within the given Number of Retries. |
| Execution | IVR |
| Context | |

²Based on the java implementation of the Gregorian calendar

1.10. Prompt For Integer Value

| Input | | Output | |
|---|---|---|---|
| Field Name | Value | Field Name | Value |
| Action | 11 | ActionResultSuccess | True/false |
| ActionDataInt | Input Length | ActionResultInt | |
| ActionDataFloat | Number of | ActionResultFloat | |
| | Retries | | |
| ActionDataStr | .wav filename | ActionResultStr | Entered |
| | (prompt), | | Value |
| | .wav filename | ActionResultDate | |
| | (fail msg) | | |
| ActionDataDate | | | |

| | |
|---|---|
| Success Conditions | |
| Failure Conditions | The user fails to enter a valid number after |
| | ActionDataFloat attempts. |
| Execution Context | IVR |

1.11. Prompt For Decimal Value

| Input | | Output | |
|---|---|---|---|
| Field Name | Value | Field Name | Value |
| Action | 17 | ActionResultSuccess | true |
| ActionDataInt | Number of Retries | ActionResultInt | |
| ActionDataFloat | Denomiator value | ActionResultFloat | Value entered |
| ActionDataStr | .wav filename (prompt), | ActionResultStr | |
| | .wav filename (fail msg) | ActionResultDate | |
| ActionDataDate | | | |

| | |
|---|---|
| Success Conditions | User must have entered a numeric value that may be parsed into a |
| | floating-point number. The number the user entered is divided by |
| | ActionDataFloat and returned in the ActionDataFloat field. |
| Failure Conditions | The user fails to enter a valid number after ActionDataInt attempts. |
| Execution Context | IVR |

1.12. Send DTMF

| Input | | Output | |
|---|---|---|---|
| Field Name | Value | Field Name | Value |
| Action | 18 | ActionResultSuccess | true |
| ActionDataInt | | ActionResultInt | |
| ActionDataFloat | | ActionResultFloat | |
| ActionDataStr | DTMF sequence | ActionResultStr | |
| ActionDataDate | | ActionResultDate | |

| | |
|---|---|
| Success Conditions | The Send DTMF action always returns true |
| Failure Conditions | |
| Execution Context | IVR |

1.13. Receive DTMF

| Input | | Output | |
|---|---|---|---|
| Field Name | Value | Field Name | Value |
| Action | 19 | ActionResultSuccess | True/false |
| ActionDataInt | Length descriptor | ActionResultInt | |
| ActionDataFloat | Number of Retries | ActionResultFloat | |
| ActionDataStr | .wav filename (prompt), | ActionResultStr | DTMF Digits |
| | .wav filename (fail msg) | ActionResultDate | |
| ActionDataDate | | | |

| | |
|---|---|
| Success Conditions | The Receive DTMF action will return true when |
| | 1. The ActionDataInt is positive and the user enters the number of |
| | digits defined by ActionDataInt |
| | 2. The ActionDataInt value is negative, and the user enters up to |
| | the number of digits defined by ABS(ActionDataInt) |
| Failure Conditions | The user fails to enter a valid number of digits (based on the |
| | ActionDataInt value) within the ActionDataFloat attempts. |
| Execution Context | IVR |

### Controlling Call Flow

1.14. Menu

The Menu Action dynamically creates a menu based on prompts that must exist on the server. If a filter is supplied, then any key pressed by the user that is not contained within that filter is rejected by the IVR.

| Input | | Output | |
|---|---|---|---|
| Field Name | Value | Field Name | Value |
| Action | 5 | ActionResultSuccess | True/false |
| ActionDataInt | Number of | ActionResultInt | |
| | Retries | | |
| ActionDataFloat | | ActionResultFloat | |
| ActionDataStr | [Filter](,.wav | ActionResultStr | Menu Selection |
| | Filename)+ | ActionResultDate | |
| ActionDataDate | | | |

| | |
|---|---|
| Success Conditions | This action will succeed if the user selects on |
| | of the available menu options before the Number |
| | of Retries expires. |
| Failure Conditions | This Action will fail if the user exceeds the |
| | number of retries without entering a valid |
| | menu selection. |
| Execution Context | IVR |

1.15. Call Redirect

| Input | | Output | |
|---|---|---|---|
| Field Name | Value | Field Name | Value |
| Action | 6 | ActionResultSuccess | true |
| ActionDataInt | | ActionResultInt | 1 = Success |
| ActionDataFloat | | | −1 = Busy |
| ActionDataStr | Transfer | | −2 = Invalid |
| | number | | |
| ActionDataDate | | | −3 = Unsuccessful |
| | | ActionResultFloat | |
| | | ActionResultStr | |
| | | ActionResultDate | |

| | |
|---|---|
| Success Conditions | This Action always returns true. The |
| | ActionResultInt must be used to determine the |
| | actual result of the Action. |
| Failure Conditions | |
| Execution Context | IVR |

1.16. Transfer to Queue

The Transfer To Queue action handles the complex task of placing a customer on hold while waiting for their call to be serviced by an available customer service representative. Information may be passed into this command for use in: communicating with the customer about their anticipated hold time; sending to the rep's screen upon connection; and determining when the queue is expected to close.

| | |
|---|---|
| Field Name | Value |

Input

| Action | 14 | |
|---|---|---|
| ActionDataInt | Contact Service Queue ID | |
| ActionDataFloat | Hold Time between retries | |
| ActionDataStr | A comma-separated list of the following values: | |
| | TransferQueueName | The name of the Contact Service Queue |
| | Hold Prompt | Filename of the prompt to play |
| | Secondary Prompt | Filename to play if the call has not connected |
| | | after 1st hold |
| | Ternary Prompt | Filename to play if the estimated hold time > |
| | | threshold |
| | HvyCallVolThreshold | Number of minutes required to wait before |
| | | playing Ternary Prompt |
| | IncludeHoldTime | Whether or not to say the estimated hold time |
| | MinutesSuffix | Filename of the ‘minutes’ prompt |
| | SecondsSuffix | Filename of the ‘seconds’ prompt |
| | Screen | The TSYS Screen to pop ex: IGB |
| | AccountNumber | The caller's account number |
| | ContextID | The JobAid contet ID |
| | System | The System |
| | CampaignID | The Dialer Campaign Identifier |
| | QueueRepeatCount | Number of times to repeat the hold/play |
| | | prompt loop |

| | |
|---|---|
| ActionDataDate | Closure time of the queue |

Output

| ActionResultSuccess | |
|---|---|
| ActionResultInt | 1: connected |
| | −1: queue closed |
| | −2: not connected |
| ActionResultFloat | |
| ActionResultStr | Resource ID of customer service rep |
| ActionResultDate | |
| Success Conditions | This action will succeed only if a customer service rep is available and |
| | confirmed in the specified queue, and the connection has been |
| | completed to the rep. |
| Failure Conditions | The action will fail if the schedule for the Agency indicates that the |
| | agency is closed. |
| | This action will fail when a customer service rep has not become |
| | available after the specified Number of Retries. |
| Execution Context | IVR |

1.17. Transfer Direct

The Transfer to Agency action may be used in conjunction with an inbound DNIS that supports Transfer Direct. The action will send *8 plus the supplied transfer number across the line to have the call directly transferred.

| Input | | Output | |
|---|---|---|---|
| Field Name | Value | Field Name | Value |
| Action | 23 | ActionResultSuccess | true |
| ActionDataInt | | ActionResultInt | 0: Success |
| ActionDataFloat | | | −1: Agency closed |
| ActionDataStr | Transfer | ActionResultFloat | |
| | Number | | |
| ActionDataDate | | ActionResultStr | |
| | | ActionResultDate | |

| | |
|---|---|
| Success Conditions | Once the action is passed to the IVR, the action |
| | will always return true. |
| Failure Conditions | The action will fail if the schedule for the |
| | Agency indicates that the agency is closed. |
| Execution Context | IVR/Controller |

1.18. End Call

| | |
|---|---|
| Input | Output |

| Field Name | Value | Field Name | Value |
|---|---|---|---|
| Action | 99 | ActionResultSuccess | |
| ActionDataInt | | ActionResultInt | |
| ActionDataFloat | | ActionResultFloat | |
| ActionDataStr | | ActionResultStr | |
| ActionDataDate | | ActionResultDate | |

| | |
|---|---|
| Success Conditions | This action will not return action result codes. |
| Failure Conditions | |
| Execution Context | IVR |

### Utility Functions

1.19. No Op

The No Op Action instructs the IVR to perform a simple loop without interaction with the customer.

| | |
|---|---|
| Input | Output |

| Field Name | Value | Field Name | Value |
|---|---|---|---|
| Action | 0 | ActionResultSuccess | |
| ActionDataInt | | ActionResultInt | |
| ActionDataFloat | | ActionResultFloat | |
| ActionDataStr | | ActionResultStr | |
| ActionDataDate | | ActionResultDate | |

| | |
|---|---|
| Success Conditions | This action always returns true. |
| Failure Conditions | |
| Execution Context | IVR |

1.20. Set Language

The Set Language Action establishes the language used when selecting prompts or creating prompts from values that may be formatted differently based on region (like dates).

| Input | | Output | |
|---|---|---|---|
| Field Name | Value | Field Name | Value |
| Action | 12 | ActionResultSuccess | true |
| ActionDataInt | 1 = English | ActionResultInt | |
| | 2 = Spanish | ActionResultFloat | |
| ActionDataFloat | | ActionResultStr | |
| ActionDataStr | | ActionResultDate | |
| ActionDataDate | | | |

| | |
|---|---|
| Success Conditions | This action always returns true. If the ActionDataInt |
| | is outside of the allowed range, the language |
| | will be set to the system default language (English). |
| Failure Conditions | |
| Execution Context | IVR/Controller (Upon completion of this |
| | action, the Controller updates the internal Language |
| | setting of the Session for use by Call Flows where |
| | the behavior may depend on the language). |

1.21. Set Call Priority

The Set Call Priority Action changes (either relatively or absolutely) the priority of the call. By default the call priority is 1. The maximum priority is 10.

| Input | | Output | |
|---|---|---|---|
| Field Name | Value | Field Name | Value |
| Action | 3 | ActionResultSuccess | true |
| ActionDataInt | Absolute Priority | ActionResultInt | |
| ActionDataFloat | (+/−) Relative Priority | ActionResultFloat | |
| ActionDataStr | | ActionResultStr | |
| ActionDataDate | | ActionResultDate | |

| | |
|---|---|
| Success Conditions | This action always returns true. |
| Failure Conditions | |
| Execution Context | IVR |

1.22. Pause

The Pause Action instructs the IVR to pause execution for the specified duration.

| Input | | Output | |
|---|---|---|---|
| Field Name | Value | Field Name | Value |
| Action | 15 | ActionResultSuccess | |
| ActionDataInt | Number of Seconds | ActionResultInt | |
| ActionDataFloat | | ActionResultFloat | |
| ActionDataStr | | ActionResultStr | |
| ActionDataDate | | ActionResultDate | |

| | |
|---|---|
| Success Conditions | This action always returns true. |
| Failure Conditions | |
| Execution Context | IVR |

1.23. Loopback

The Loopback Action instructs the system to bypass the IVR and return any input parameters as the output parameters of the command.

| Input | | Output | |
|---|---|---|---|
| Field Name | Value | Field Name | Value |
| Action | 20 | ActionResultSuccess | (always true) |
| ActionDataInt | | ActionResultInt | (ActionDataInt) |
| ActionDataFloat | | ActionResultFloat | (ActionDataFloat) |
| ActionDataStr | | ActionResultStr | (ActionDataStr) |
| ActionDataDate | | ActionResultDate | (ActionDataDate) |

| | |
|---|---|
| Success Conditions | This action always returns true. |
| Failure Conditions | |
| Execution Context | Controller |

1.24. Adjust Counter

The Adjust Counter action instructs the system to increment, decrement, or reset the call session's utility counter.

| Input | | Output | |
|---|---|---|---|
| Field Name | Value | Field Name | Value |
| Action | 25 | ActionResultSuccess | true |
| ActionDataInt | 1: Increment Counter | ActionResultInt | |
| | 0: Reset Counter | ActionResultFloat | |
| | −1: Decrement | ActionResultStr | |
| | Counter | | |
| ActionDataFloat | | ActionResultDate | |
| ActionDataStr | | | |
| ActionDataDate | | | |

| | |
|---|---|
| Success Conditions | This action always returns true. |
| Failure Conditions | |
| Execution Context | Controller |

### Scheduling

Contact Service Queues

External Agencies

### Runtime Management

### TBP

Dynamic Call Flow/Session attributes

### TBP

### Compilation

| Diagram Component | Commands |
|---|---|
| Adjust Counter | |
| Check By Phone | |
| Choice Point | |
| Choice Point Guard | |
| End | |
| Enqueue Call | |
| Failure | |
| Jump | |
| Keypad Entry | |
| Menu | |
| MQ Activate | |
| MQ Fetch | |
| Nag | Compilation Failure |
| Pause | IVR Pause Action |
| Play Prompt | |
| Set Attribute Value | |
| Set Call Priority | |
| Set Language | |
| Soundbyte | |
| Start | |
| Transfer | |
| Transfer to Agency | |

1. A method comprising:
providing an IVR Interactive Voice Response system for processing incoming telephone calls;
programming the IVR system to implement desired call flows;
implementing a graphical diagramming tool to support said programming desired call flows;
the diagramming tool including means for graphically representing the customer experience during the call, the graphical representations including indicia for graphically connecting indicia representing IVR actions and decision points to form a call flow diagram;
the diagramming tool further including means for translating the call flow diagram in a Finite State Machine (FSM), and storing the result in a database;
providing a controller application program coupled to the IVR; and
during a call, executing the State Machine (FSM) in the controller application program to control the IVR to implement the designed call flow.
